(19) United States
(12) Patent Application Publication
(10) Pub. No.: US 2015/0063203 A1
(43) Pub. Date: Mar. 5, 2015

(54) METHOD OF DESIGNING AND COMMUNICATING BEAM IN COMMUNICATION SYSTEM

(71) Applicant: Electronics and Telecommunications Research Institute, Daejeon (KR)

(72) Inventors: Hee Wook KIM, Daejeon (KR); Kunseok KANG, Daejeon (KR); Bon Jun KU, Daejeon (KR); Do-Seob AHN, Daejeon (KR)

(21) Appl. No.: 14/302,650

(22) Filed: Jun. 12, 2014

(30) Foreign Application Priority Data
Aug. 29, 2013 (KR) 10-2013-0103442

(51) Int. Cl. H04B 7/185; H04B 7/04

(52) U.S. Cl. CPC H04B 7/18513; H04B 7/0408
USPC 370/326

(57) ABSTRACT

A method of designing and communicating a beam in a communication system is provided. More particularly, a method of designing and communicating a beam in a communication system using carrier aggregation in order to increase a maximum data rate in a multiple beam mobile communication system is provided. By applying carrier aggregation, a maximum data rate can be improved.

### CROSS-REFERENCE TO RELATED APPLICATION

This application claims priority to and the benefit of Korean Patent Application No. 10-2013-01 03442 filed in the Korean Intellectual Property Office on Aug. 29, 2013, the entire contents of which are incorporated herein by reference.

### BACKGROUND OF THE INVENTION

(a) Field of the Invention

The present invention relates to a method of designing and communicating a beam in a communication system. More particularly, the present invention relates to a method of designing and communicating a beam in a communication system using carrier aggregation in order to increase a maximum data rate in a multiple beam mobile communication system.

(b) Description of the Related Art

Carrier aggregation (CA) is technology that makes a wideband and communicates with the wideband by simultaneously using different frequency bands.

A long term evolution (LTE)-based communication system can enlarge a frequency that supports a maximum of 20 MHz to a frequency that supports a maximum of 100 MHz using such carrier aggregation.

A terminal that supports LTE-Advanced simultaneously receives two frequencies to provide a service, and a terminal that supports general LTE uses an individual frequency with a multicarrier method.

For example, a communication method in a base station using two frequency bands (e.g., 850 MHz, 1.8 GHz) is described as follows.

When a terminal that does not support carrier aggregation and a terminal that supports carrier aggregation communicate, the terminal that does not support carrier aggregation can communicate to a maximum of 75 Mbps at 850 MHz or 1.8 GHz with a multicarrier, and the terminal that supports carrier aggregation can communicate to a maximum of 150 Mbps by simultaneously communicating at 850 MHz and 1.8 GHz through carrier aggregation.

Because coverage on a band basis is different, the terminal that supports carrier aggregation has a merit that it can communicate with only one frequency like the terminal that does not support carrier aggregation according to a position or an electric wave receiving state.

Carrier aggregation may be considered in various forms according to a provider's service scenario in ground mobile communication.

For example, in an LTE support communication system, a single carrier of 1.4, 3, 5, 10, 15, and 20 MHz is defined, and in an LTE-Advanced support communication system, a carrier that is defined in the LTE support communication system is defined as a component carrier (CC), and carrier aggregation that aggregates and simultaneously uses CCs is defined.

The CC can be formed in 5 aggregations, and a maximum bandwidth of a communication system that supports LTE-Advanced may be 100 MHz.

A kind of a carrier aggregation combination is classified into a carrier aggregation combination within the same band (an intra-band CA) and a carrier aggregation combination between different bands (an inter-band CA). The intra-band CA includes an intra-band contiguous CA used when aggregating CCs that are continuously formed in the same band, and an intra-band non-contiguous CA used when aggregating CCs that are not continuously formed in the same band.

When forming a carrier aggregation CA network, coverage may be different on a carrier basis, and cell design scenarios of several forms exist according to a provider policy.

Therefore, by enabling to have the same coverage, entire throughput can be improved, or by enabling another carrier to have coverage that supplements a weak area of another carrier cell, throughput in a cell boundary area can be improved.

In an LTE carrier aggregation CA system in which standardization is complete, because the terminal simultaneously uses two frequencies, the terminal communicates with two cells, and one of the two cells is referred to as a primary cell (PCell) and the other one is referred to as a secondary cell (SCell).

The terminal communicates by first setting a radio resource control (RRC) connection through a PCell, and when a radio resource is additionally necessary, the terminal may simultaneously receive data through a PCell and an SCell by setting an RRC connection with an SCell through an RRC connection reconfiguration process. Even if data is received through two cells, data that the terminal sends is transmitted only to the PCell, and system information acquisition and handover control is performed through the PCell.

However, a multiple beam mobile satellite communication system has characteristics that do not generally use frequency reuse 1 and in which a beam is designed through at least one frequency reuse, and in which a terminal performance difference is not large between a beam central area and a beam boundary area, unlike a ground mobile communication system.

Therefore, a maximum data rate of a multiple beam satellite communication system can be improved through a carrier aggregation-based beam design and communication method in consideration of characteristics of such a multiple beam mobile satellite communication system.

### SUMMARY OF THE INVENTION

The present invention has been made in an effort to provide a method of designing and communicating a beam in a communication system that can improve a maximum data rate by applying carrier aggregation.

An exemplary embodiment of the present invention provides a method in which a satellite base station and a terminal communicate using carrier aggregation, the method including: detecting, by the terminal, a multiple beam downlink signal; selecting, by the terminal, a primary beam using strength of the detected multiple beam downlink signal or a position of the terminal; selecting, by the terminal, a secondary beam using the primary beam and the strength of the detected multiple beam downlink signal or the position of the terminal; transmitting, by the terminal, information about the secondary beam to the satellite base station; and communicating, by the terminal and the satellite base station, by applying carrier aggregation to the primary beam and the secondary beam.

The transmitting of information about the secondary beam may include transmitting, by the terminal, information about the secondary beam by attempting random access through a random access preamble sequence corresponding to the selected secondary beam among random access preamble sequences that are formed in a group by the number of adjacent beams.

The transmitting of information about the secondary beam may include receiving, by the terminal, a request about channel state information through the primary beam and transmitting carrier information of the secondary beam so as to know a channel situation of the secondary beam from the satellite base station.

The transmitting of carrier information of the secondary beam may include transmitting using a bit corresponding to unnecessary information or adding and transmitting to a bit for transmitting the channel state information in a multiple beam satellite communication system among bits for transmitting channel state information.

The transmitting of information about the secondary beam may include transmitting, when the terminal attempts random access to the satellite base station through the secondary beam and when random access to the satellite base station has succeeded, information about the secondary beam to the primary beam.

The terminal may transmit resource allocation information for the primary beam and the secondary beam through a control information channel of the primary beam.

The selecting of a secondary beam may include determining, by the terminal, the number of secondary beams to select according to a requested maximum transmission speed and searching for the secondary beams of the determined number, but reducing and searching for, if the secondary beam is not found, the determined number of secondary beams.

Another embodiment of the present invention provides a method in which a satellite base station and a terminal communicate using carrier aggregation, the method including: determining, by the terminal, a position on a structure in which a first multiple beam structure and a second multiple beam structure are partially overlapped; selecting a primary beam and a secondary beam according to the position that the terminal determines; and communicating, by the terminal and the satellite base station, by applying carrier aggregation to the primary beam and the secondary beam.

The first multiple beam structure and the second multiple beam structure may be a connected structure of a hexagon and may be formed so that signal strength by each beam is strong at the center of each hexagon, the overlapped structure may be a structure that is overlapped by moving on an extension line of one side by a length of the one side of a hexagon in a state in which a hexagon within the first multiple beam structure and a hexagon within the second multiple beam structure are stacked to be overlapped, and the selecting of a primary beam and a secondary beam may include determining that the terminal is positioned at which triangle of triangles by vertexes that are shared by a hexagon within the first multiple beam structure and a hexagon within the second multiple beam structure within the overlapped structure and selecting the primary beam and the secondary beam according to the determined triangle.

The first multiple beam structure and the second multiple beam structure may be a connected structure of a hexagon and may be formed so that signal strength by each beam is strong at the center of each hexagon, the overlapped structure may be a structure in which vertexes of a hexagon within the first multiple beam structure and vertexes of a hexagon within the second multiple beam structure are stacked not to be overlapped, and it may be determined whether the terminal is positioned at which quadrangle of quadrangles that connect points in which the side of a hexagon within the first multiple beam structure within the overlapped structure and the side of a hexagon within the second multiple beam structure meet, and the primary beam and the secondary beam may be selected according to the determined quadrangle.

The detailed matters of the exemplary embodiments will be included in the detailed description and the drawings.

According to the present invention, by applying carrier aggregation, a maximum data rate can be improved.

### BRIEF DESCRIPTION OF THE DRAWINGS

FIG. 1 is a block diagram illustrating a multiple beam structure for providing a communication service that supports both ground communication and satellite communication through a satellite.

FIG. 2 is a block diagram illustrating a multiple beam design structure according to an exemplary embodiment of the present invention.

FIG. 3 is a flowchart illustrating a communication method of applying carrier aggregation in a multiple beam satellite communication system according to an exemplary embodiment of the present invention.

FIG. 4 is a flowchart illustrating a method of selecting a secondary beam according to an exemplary embodiment of the present invention.

FIG. 5 is a flowchart illustrating a method of selecting a secondary beam according to another exemplary embodiment of the present invention.

FIG. 6 is a flowchart illustrating a method of selecting a secondary beam according to another exemplary embodiment of the present invention. FIG. 7 is a block diagram illustrating a multiple beam design structure according to another exemplary embodiment of the present invention.

FIG. 8 is a block diagram illustrating a multiple beam design structure according to another exemplary embodiment of the present invention.

### DETAILED DESCRIPTION OF THE EMBODIMENTS

These and other objects of the present application will become more readily apparent from the detailed description given hereinafter together with the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description. Terms used in this specification are not to limit the present invention but are used to illustrate exemplary embodiments.

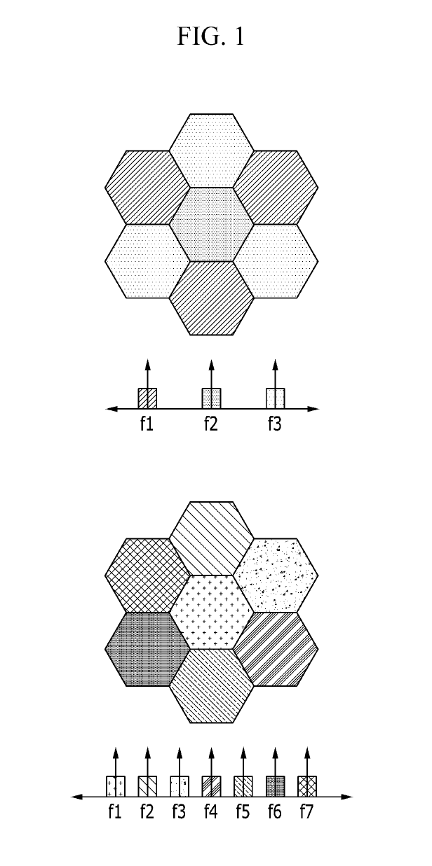

FIG. 1 is a block diagram illustrating a multiple beam structure for providing a communication service that supports both ground communication and satellite communication through a satellite. Referring to FIG. 1, a block diagram that is shown at the left side illustrates a multiple beam structure of frequency reuse 3, and a block diagram that is shown at the right side illustrates a multiple beam structure of frequency reuse 7.

In such two cases, spectrum efficiency is excellent in a multiple beam structure like the block diagram that is shown at the left side that efficiently reuses the small number of frequencies, but much interference occurs by a beam using the same frequency.

Therefore, frequency reuse should consider the number of carriers that can be used, throughput of a requested beam, and a satellite beam antenna pattern.

Such a multiple beam structure has a limitation in sharply making an antenna beam pattern, unlike a ground communication system, and in order to provide a constant link budget regardless of a user position, a receiving power difference between the beam center and a beam boundary area is small.

For example, a beam boundary area may be designed to have a 3 dB beam width from the beam center.

That is, a ground communication system uses frequency reuse 1, and because a receiving power difference between the beam center and a beam boundary area increases by path loss, there is a limitation in using carrier aggregation between adjacent beams. However, a multiple beam satellite communication system uses different carriers between adjacent beams, and because a receiving power difference between a beam boundary and a beam central area is not large, carrier aggregation between multicarriers having similar coverage may be used.

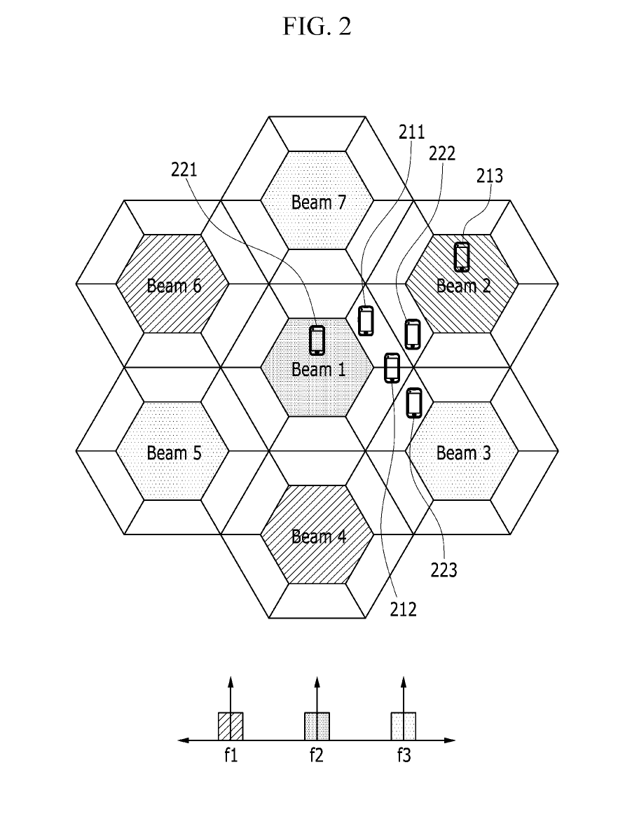

FIG. 2 is a block diagram illustrating a multiple beam design structure according to an exemplary embodiment of the present invention. FIG. 2 illustrates that carrier aggregation is used in a multiple beam satellite communication system using frequency reuse 3. Even in a case of another frequency reuse, the same principle can be applied.

Referring to FIG. 2, a multiple beam satellite communication system supports communication of carrier aggregation (CA) terminals 211, 212, and 213 that support CA technology, and multi-carrier (MC) terminals 221, 222, and 223 that do not support carrier aggregation and that communicate through only one carrier of each beam.

The MC terminals 221, 222, and 223 communicate through a carrier of a beam having a position of the terminal as coverage regardless of a position of the terminal.

Referring to FIG. 2, the MC terminal 221 that is positioned in a beam central area communicates through a beam 1 carrier, the MC terminal 222 in a boundary area of a beam 2 adjacent to a beam 1 communicates through the beam 2 carrier, and the MC terminal 223 in a boundary area of a beam 3 adjacent to the beam 1 and the beam 2 communicates through a beam 3 carrier.

However, the CA terminals 211, 212, and 213 that support carrier aggregation use appropriate carrier aggregation according to a position of the terminal.

As shown in FIG. 2, the CA terminal 211 in a boundary area of the beam 1 adjacent to the beam 2 may have a data rate of a maximum of two times by communicating by applying carrier aggregation to the beam 1 carrier and the beam 2 carrier.

In order to apply such carrier aggregation, the terminal should determine a primary beam and a secondary beam to communicate with the terminal, and preferably, a beam in which strength of a received signal is stronger is determined as a primary beam.

That is, the CA terminal 211 applies carrier aggregation in which the beam 1 is used as a primary beam and in which the beam 2 is used as a secondary beam. The CA terminal 211 transmits important information such as system information through the primary beam, and resource allocation information for the primary beam and the secondary beam is transmitted through a control information channel of the primary beam. Further, resource allocation information for each beam may be formed to be independently transmitted through a control information channel of each beam.

When transmitting resource allocation information for the primary beam and the secondary beam through a control information channel of the primary beam, crossing scheduling is available and thus a scheduling diversity gain can be obtained.

The CA terminal 212 in a boundary area of the beam 1 adjacent to the beam 2 and the beam 3 may have a data rate of a maximum of three times by communicating using a beam 1 carrier, a beam 2 carrier, and a beam 3 carrier by applying carrier aggregation.

The CA terminal 212 should determine a primary beam and two secondary beams, and preferably, a beam in which strength of a received signal is stronger is determined as a primary beam.

That is, the CA terminal 212 applies carrier aggregation that uses the beam 1 as a primary beam and that uses the beam 2 and the beam 3 as secondary beams.

Preferably, a CA terminal of an area that applies carrier aggregation using three carriers can apply carrier aggregation using two carriers by selecting one of two secondary beams.

Preferably, the CA terminal 213 that is positioned at a central area of the beam 2 may communicate through the beam 2 having coverage at a position of the terminal through one carrier like the MC terminal without applying carrier aggregation.

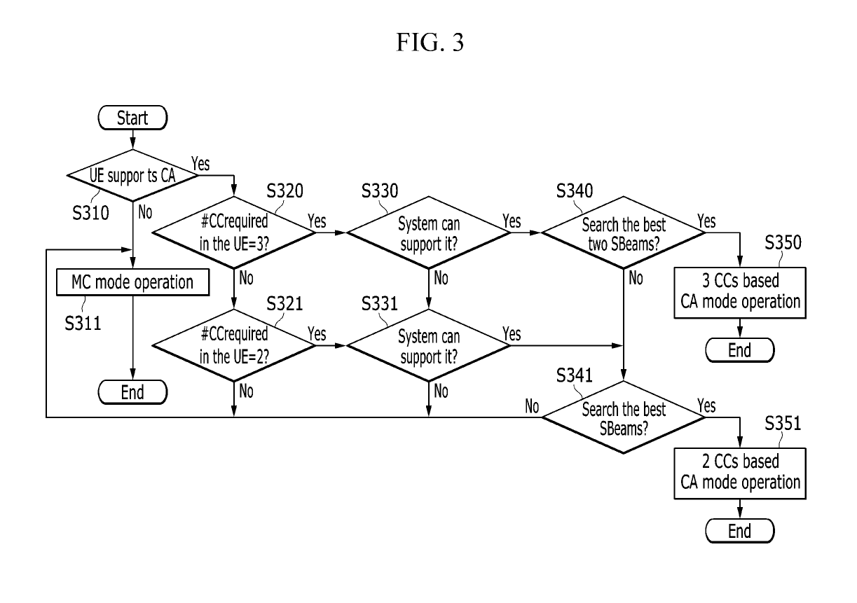

FIG. 3 is a flowchart illustrating a communication method of applying carrier aggregation in a multiple beam satellite communication system according to an exemplary embodiment of the present invention.

Referring to FIG. 3, the satellite base station determines whether the terminal to communicate supports carrier aggregation (S310).

If the terminal to communicate does not support carrier aggregation, the satellite base station operates in an MC mode (S311).

If the terminal to communicate supports carrier aggregation, the satellite base station performs the following operation.

It is assumed that a maximum transmission speed through one beam carrier is A bps or less, and the satellite base station determines whether a request transmission speed of the terminal to communicate is 2 A bps to less than 3 A bps (S320).

If a request transmission speed of the terminal to communicate is not 2 A bps to less than 3 A bps, the satellite base station determines whether a request transmission speed of the terminal to communicate is A bps or less than 2 A bps (S321).

If a request transmission speed of the terminal to communicate is 2 A bps to less than 3 A bps at step S320, the satellite base station determines whether a system supports three CC-based carrier aggregation (S330).

If a system does not support three CC-based carrier aggregation at step S330 or if a request transmission speed of the terminal to communicate is A bps to less than 2 A bps at step S321, the satellite base station determines whether two CC-based carrier aggregation is supported (S331).

If a system supports three CC-based carrier aggregation at step S330, the satellite base station searches for two secondary beams other than a primary beam (S340).

Preferably, a beam to be used for communicating may be selected by the satellite base station, but a method of selecting by the terminal and transmitting selected information to the satellite base station may be used.

Preferably, a primary beam is selected as a beam in which strength of a received signal is best, and a secondary beam is selected as a beam in which strength of a received signal is second best. Alternatively, the secondary beam is selected as a beam that can provide the best performance to the terminal together with the selected primary beam.

When two secondary beams are not found at step S340 or if two CC-based carrier aggregation is supported at step S331, the satellite base station searches for one secondary beam other than the primary beam (S341).

A method of searching for a secondary beam is similar to step S340.

When two secondary beams are found at step S340, the satellite base station applies carrier aggregation to the two found secondary beams and the primary beam (S350).

When a secondary beam is found at step S341, the satellite base station applies carrier aggregation to the found secondary beam and the primary beam (S351).

If a request transmission speed of the terminal to communicate is not A bps to less than 2 A bps at step S321, if two CC-based carrier aggregation is not supported at step S331, or when a secondary beam is not found at step S341, the satellite base station operates in an MC mode (S311).

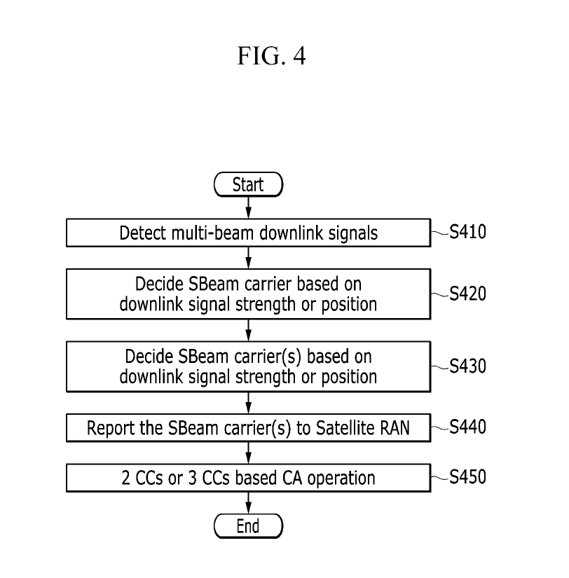

FIG. 4 is a flowchart illustrating a method of selecting a secondary beam according to an exemplary embodiment of the present invention. The following description illustrates that a terminal selects a beam and transmits selected information to a satellite base station, but it may be designed to select a beam by a satellite base station, as described above.

Referring to FIG. 4, the terminal detects multi-beam downlink signals (S410).

The terminal selects a primary beam based on strength of the detected multi-beam downlink signal or a position of the terminal (S420).

Further, the terminal selects a secondary beam based on strength of the detected multi-beam downlink signal or a position of the terminal (S430).

Preferably, the terminal selects the nearest beam to a position of the terminal or a beam having a strong received signal level, except for the primary beam.

Further, the terminal may preferably select a plurality of secondary beams.

The terminal reports a list of selected secondary beams to the satellite base station (S440).

The satellite base station applies carrier aggregation to a primary beam and a secondary beam that are selected according to information that is transmitted from the terminal (S450).

Preferably, the terminal forms 64 random access preamble sequences that are used in general LTE communication in a group by the number of adjacent beams, and reports information about a selected secondary beam to a satellite base station with a method of attempting random access through a random access preamble sequence corresponding to a beam to select as a secondary beam. In this case, the satellite base station may determine a secondary beam that the terminal wants by detecting random access sequences that are formed and transmitted in a group, and perform carrier aggregation-based multiple beam mobile communication based on determined information.

Preferably, in a multiple beam satellite system that supports carrier aggregation using three CCs, because the satellite base station should divide a terminal that transmits information about one secondary beam and a terminal that transmits information about two secondary beams, it should be determined whether to support carrier aggregation using several CCs in consideration of a problem in which the number of random access sequences that can be used within a group is reduced due to an increase of the group number of random access sequences or a problem in which a detection time of a random access sequence increases by increasing the number of random access sequences for a CA terminal.

When a random access preamble sequence is not used, it may be designed with a method of additionally transmitting information about a secondary beam when transmitting terminal information at initial access of the terminal.

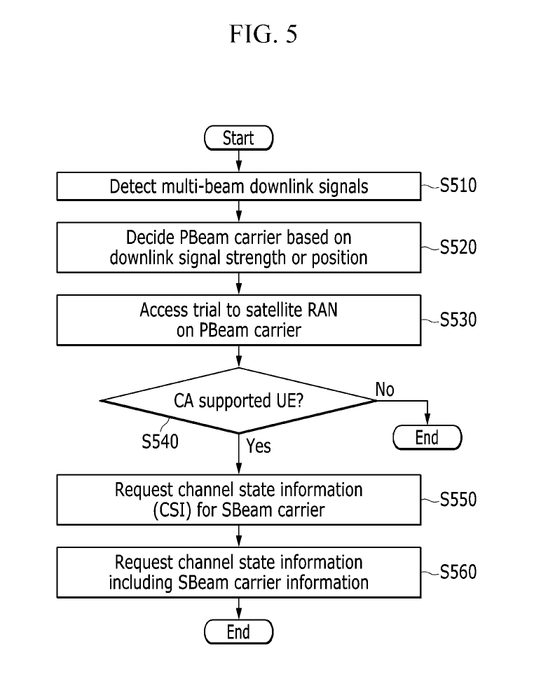

FIG. 5 is a flowchart illustrating a method of selecting a secondary beam according to another exemplary embodiment of the present invention.

Referring to FIG. 5, the terminal detects multi-beam downlink signals (S510).

The terminal selects a primary beam based on strength of a detected multi-beam downlink signal or a position of the terminal (S520).

The terminal attempts random access with a satellite base station through a primary beam (S530).

The satellite base station determines whether the terminal having attempted random access is a terminal that can use carrier aggregation (S540), and if the terminal having attempted random access is not a terminal that can use carrier aggregation, the satellite base station communicates with the terminal through a primary beam.

If the terminal having attempted random access is a terminal that can use carrier aggregation, in order to report a channel situation of a secondary beam to the terminal, the satellite base station requests channel state information (CSI) with a primary beam uplink (S550).

The satellite base station receives secondary beam carrier information from the terminal, and determines a secondary beam carrier of the terminal and a channel state of the carrier based on the received information (S560).

Preferably, because a multiple beam satellite communication system does not have much channel state information that it should transmit, unlike a ground mobile communication system, the terminal transmits secondary beam carrier information to the satellite base station using a bit corresponding to information without necessity to transmit in a multiple beam satellite communication system among bits for transmitting channel state information in the ground mobile communication system.

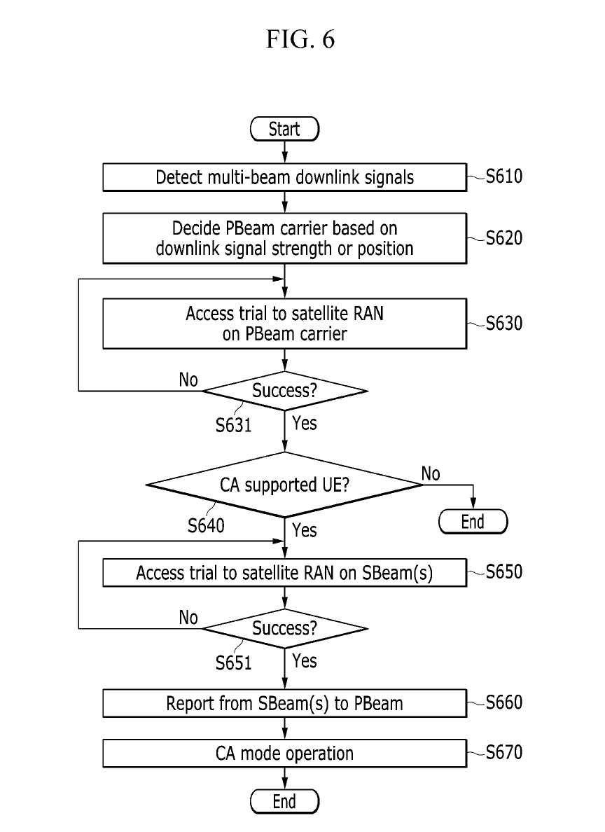

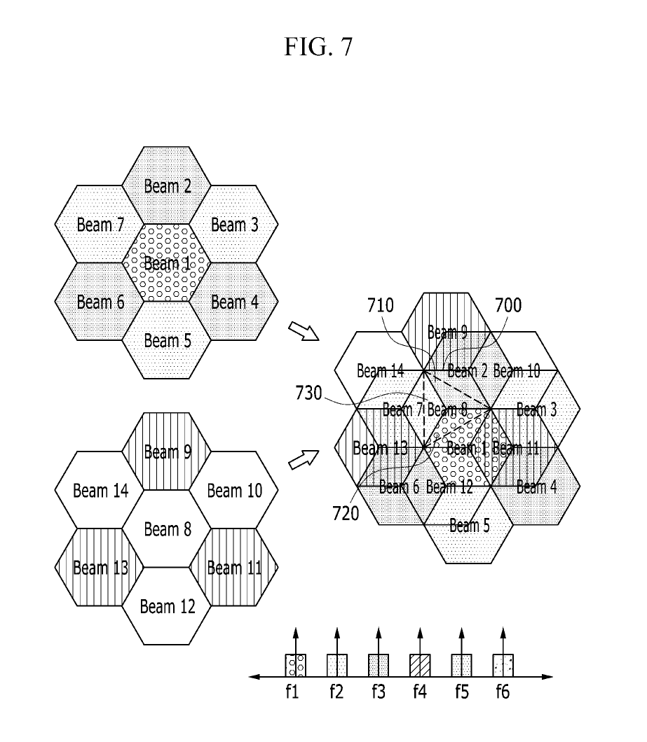

FIG. 6 is a flowchart illustrating a method of selecting a secondary beam according to another exemplary embodiment of the present invention.

Referring to FIG. 6, the terminal detects multi-beam downlink signals (S610).

The terminal selects a primary beam based on strength of the detected multi-beam downlink signal or a position of the terminal (S620).

The terminal attempts random access with a satellite base station through the primary beam (S630). The terminal determines whether random access has succeeded (S631), and if random access has succeeded, the next step is performed, and if random access has failed, the terminal repeatedly attempts random access.

The satellite base station determines whether the terminal, having attempted random access is a terminal that may use carrier aggregation (S640), and if the terminal having attempted random access is not a terminal that may use carrier aggregation, the satellite base station performs communication through the primary beam.

If the terminal having attempted random access is a terminal that may use carrier aggregation, the terminal attempts random access with the satellite base station through a secondary beam (S650). The terminal determines whether random access has succeeded (S651), and if random access has succeeded, the next step is performed, and if random access has failed, the terminal repeatedly attempts random access.

The terminal reports information about a secondary beam to the primary beam (S660).

When information about a secondary beam is reported to the primary beam, carrier aggregation is applied to the primary beam and the secondary beam (S670).

FIG. 7 is a block diagram illustrating a multiple beam design structure according to another exemplary embodiment of the present invention. FIG. 7 illustrates an example in which carrier aggregation-based beam design technology that is partially overlapped to increase a maximum data rate regardless of coverage position of a multiple beam satellite system is applied.

At the left side of FIG. 7, two multiple beam structures that are designed to have frequency reuse 3 are illustrated. A multiplex beam structure (first multiple beam structure) of an upper end portion of the left side reuses f1 to f3, and a multiple beam structure (second multiple beam structure) of a lower end portion of the left side reuses f4 to f6.

Another exemplary embodiment of the present invention suggests a multiple beam structure in which such two multiple beam structures are partially overlapped, as shown at the right side.

When the two multiple beam structures are partially overlapped, in the first multiple beam structure, the center of a specific beam becomes a boundary area of a beam in the second multiple beam structure. Therefore, a terminal of a predetermined position exists at a primary beam carrier that is determined as a beam central area in a specific multiple beam structure to provide a high data rate, and exists at a secondary beam carrier that is determined as a beam boundary area in another multiple beam structure to provide a lower data rate.

When carrier aggregation of a primary beam and a secondary beam is applied, a terminal of any position has a data rate of a similar level.

In a structure that is shown at the right side of FIG. 7, like an area 700, when a multiple beam structure that is divided into a hexagonal structure is overlapped, the multiple beam structure may be divided again into a triangular structure.

The overlapped structure is a structure that is overlapped by moving to an extension line of one side by a length of one side of a hexagon in a state in which a hexagon within the first multiple beam structure and a hexagon within the second multiple beam structure are stacked to be overlapped, and is overlapped. Therefore, in an overlapped area, a triangular structure that is formed with three vertexes that are shared by a hexagon within the first multiple beam structure and a hexagon within the second multiple beam structure exists.

That is, in the area 700 of a hexagonal structure according to a second multiple beam structure, a triangular structure that is connected by three vertexes that are selected by skipping over one vertex is formed.

In such a case, a triangle within the area 700 is divided again into three areas 710, 720, and 730 by the first multiple beam structure.

Here, by the terminal that is positioned at each area 710, 720, and 730, a primary beam by the second multiple beam structure is selected, and a secondary beam by the first multiple beam structure is selected.

Such a beam may be selected by a method that is described with reference to FIGS. 3 to 6, but as shown in FIG. 7, as an area is divided, such a beam may be selected based on a position.

The terminal should report a list of secondary beams to a satellite base station, and in this case, the following method may be used as an example.

When the terminal attempts random access through a random access preamble sequence corresponding to a beam to be selected as a secondary beam by dividing existing 64 random access preamble sequences into three groups, the satellite base station detects a transmitted random access sequence, thereby knowing a secondary beam that the terminal wants.

As another method, a method of adding a random access preamble sequence for the terminal in which information about additional secondary beam is added other than existing 64 random access preambles is considered. For example, by adding 64 random access sequences, the number of entire random access sequences becomes 128. In this case, a time when the satellite base station detects a random access sequence becomes two times, but in consideration of a long satellite reciprocating delay time, an influence on system performance is not large.

As another method that does not use a random access preamble sequence, a method in which the terminal adds and transmits information about a secondary beam of 2 bits together with terminal information in an initial access attempt to a satellite base station is considered.

Here, as described with reference to the drawing, information of 2 bits is added in consideration of frequency reuse 3, but as a case of frequency reuse is changed, a size of a bit for information about an added secondary beam may also be changed.

For example, when frequency reuse is 8 or less, 3 bits may be used, and when frequency reuse is 16 or less, 4 bits may be used.

As another method, a method that is described with reference to FIG. 5 is considered.

As another method, a method that is described with reference to FIG. 6 is considered.

Like described with reference to FIG. 7, when a beam is designed to partially cross a multiplex beam structure, which is two hexagonal structures, coverage of a primary beam decreases in a triangular structure. Further, as a boundary area of a beam reduces to a peripheral area of each vertex of a triangle, even in communication of a terminal that does not support carrier aggregation, the data rate increases and thus entire system performance can be improved.

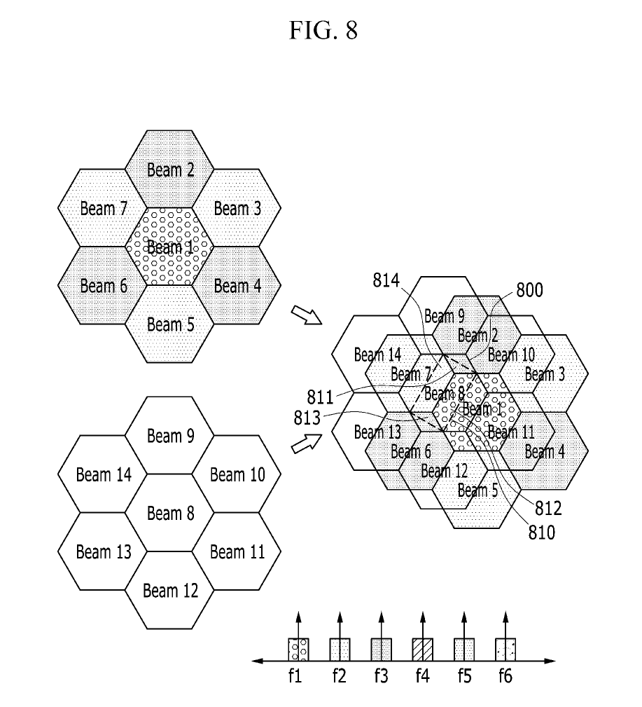

FIG. 8 is a block diagram illustrating a multiple beam design structure according to another exemplary embodiment of the present invention. FIG. 8 suggests a structure that removes a farthest boundary area from a central area of each beam by overlapping a multiple beam structure, but by overlapping a position within a hexagon of a multiple beam structure in which each vertex of a hexagon is overlapped within a multiple beam structure in which a hexagonal structure is continuously formed.

That is, an overlapped multiple beam structure is a structure in which vertexes of a hexagon within a first multiple beam structure and a hexagon within a second multiple beam structure are not overlapped.

Therefore, the overlapped multiple beam structure exists at a quadrangle that connects points in which the side of a hexagon within the first multiple beam structure and the side of a hexagon within the second multiple beam structure meet, and it is determined that a terminal is positioned at which quadrangle of such quadrangles, and a primary beam and a secondary beam are selected.

Referring to FIG. 8, an area 800 corresponding to a specific hexagon of the second multiple beam structure has an area 810 corresponding to a quadrangle that connects points of the side that meets to overlap at the inside. When the terminal is positioned within the area 810 corresponding to a quadrangle, it is determined that the terminal is positioned at which position of four areas 811, 812, 813, and 814 that are divided by the first multiple beam structure among the area 810.

The terminal selects a primary beam according to the second multiple beam structure and selects a secondary beam according to the first multiple beam structure. In the first area 811, a secondary beam corresponding to a beam 7 of the first multiple beam structure is selected, in the second area 812, a beam 6 is selected as a secondary beam, in the third area 813, a beam 1 is selected as a secondary beam, and in the fourth area 814, a beam 2 is selected as a secondary beam.

In the foregoing description, an exemplary embodiment and an application example of the present invention have been described, but the present invention is not limited to the specific exemplary embodiment and application example, and it will be apparent to those skilled in the art that various modifications and variations may be made without departing from the spirit or scope of the invention. Thus, it is intended that the present invention cover the modifications and variations of this invention provided they come within the scope of the appended claims and their equivalents.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a satellite base station and a terminal communicate using carrier aggregation, the method comprising:
detecting, by the terminal, a multiple beam downlink signal;
selecting, by the terminal, a primary beam using strength of the detected multiple beam downlink signal or a position of the terminal;
selecting, by the terminal, a secondary beam using the primary beam and the strength of the detected multiple beam downlink signal or the position of the terminal;
transmitting, by the terminal, information about the secondary beam to the satellite base station; and
communicating, by the terminal and the satellite base station, by applying carrier aggregation to the primary beam and the secondary beam.

2. The method of claim 1, wherein the transmitting of information about the secondary beam comprises transmitting, by the terminal, information about the secondary beam by attempting random access through a random access preamble sequence corresponding to the selected secondary beam among random access preamble sequences that are formed in a group by the number of adjacent beams.

3. The method of claim 1, wherein the transmitting of information about the secondary beam comprises receiving, by the terminal, a request about channel state information through the primary beam and transmitting carrier information of the secondary beam so as to know a channel situation of the secondary beam from the satellite base station.

4. The method of claim 3, wherein the transmitting of carrier information of the secondary beam comprises transmitting using a bit corresponding to unnecessary information or adding and transmitting to a bit for transmitting the channel state information in a multiple beam satellite communication system among bits for transmitting channel state information.

5. The method of claim 1, wherein the transmitting of information about the secondary beam comprises transmitting, when the terminal attempts random access to the satellite base station through the secondary beam and when random access to the satellite base station has succeeded, information about the secondary beam to the primary beam.

6. The method of claim 1, wherein the terminal transmits resource allocation information for the primary beam and the secondary beam through a control information channel of the primary beam.

7. The method of claim 1, wherein the selecting of a secondary beam comprises determining, by the terminal, the number of secondary beams to select according to a requested maximum transmission speed and searching for the secondary beams of the determined number, but reducing and searching for, if the secondary beam is not found, the determined number of secondary beams.

8. A method in which a satellite base station and a terminal communicate using carrier aggregation, the method comprising:
determining, by the terminal, a position on a structure in which a first multiple beam structure and a second multiple beam structure are partially overlapped;
selecting a primary beam and a secondary beam according to the position that the terminal determines; and
communicating, by the terminal and the satellite base station, by applying carrier aggregation to the primary beam and the secondary beam.

9. The method of claim 8, wherein the first multiple beam structure and the second multiple beam structure are a connected structure of a hexagon and are formed so that signal strength by each beam is strong at the center of each hexagon,
the overlapped structure is a structure that is overlapped by moving on an extension line of one side by a length of the one side of a hexagon in a state in which a hexagon within the first multiple beam structure and a hexagon within the second multiple beam structure are stacked to be overlapped, and
the selecting of a primary beam and a secondary beam comprises determining that the terminal is positioned at which triangle of triangles by vertexes that are shared by a hexagon within the first multiple beam structure and a hexagon within the second multiple beam structure within the overlapped structure and selecting the primary beam and the secondary beam according to the determined triangle.

10. The method of claim 8, wherein the first multiple beam structure and the second multiple beam structure are a connected structure of a hexagon and are formed so that signal strength by each beam is strong at the center of each hexagon,
the overlapped structure is a structure in which vertexes of a hexagon within the first multiple beam structure and vertexes of a hexagon within the second multiple beam structure are stacked not to be overlapped, and
it is determined whether the terminal is positioned at which quadrangle of quadrangles that connect points in which the side of a hexagon within the first multiple beam structure within the overlapped structure and the side of a hexagon within the second multiple beam structure meet, and the primary beam and the secondary beam are selected according to the determined quadrangle.
